(19) United States
(12) Patent Application Publication
(10) Pub. No.: US 2012/0130773 A1
(43) Pub. Date: May 24, 2012

(54) System and method for determining applicants' working process with an administrative agency based on past data collection and analysis of past administrative agents performance

(76) Inventors: Maad Abu-Ghazalah, Sunnyvale, CA (US); Michael W. Starkweather, Sandy, UT (US)

(21) Appl. No.: 13/297,189

(22) Filed: Nov. 15, 2011

Related U.S. Application Data
(60) Provisional application No. 61/413,862, filed on Nov. 15, 2010.

(51) Int. Cl. G06Q 10/06

(52) U.S. Cl. 705/7.38

(57) ABSTRACT

A computer implemented process for predicting a next course of action to increase the probability of allowance of an application that is before an administrative agent in an administrative agency. Specifically, the system comprising: a computer system for automatically analyzing and providing recommendations to the applicants; a receiving data module, in communication with the computer system, designed to receive data related the past performance of the administrative agents actions; analyzing data module, in communication with the computer system and the receiving data module, and designed to analyze all data related to the past performance of an administrative agents actions; and a display module, in communication with the analyzing data module, and designed to display to a user a report of the past performance of the administrative agent, related administrative agents performance, and complete administrative agency performance.

### CROSS-REFERENCE TO RELATED APPLICATIONS

This invention has claims of priority, under 35 U.S.C. §120, to U.S. Provisional Patent app. No. 61/413,862, filed on Nov. 15, 2010, with atty. Docket no. 4007.2.1P with the same title as this application, which is incorporated by reference herein. This invention claims no priority, under 35 U.S.C. §119, to any foreign patent application, which would be incorporated by reference herein. This application is not a Divisional application of, under 35 U.S.C. §121, and claims no priority under 35 U.S.C. §121, to a United States Non-Provisional Application.

### BACKGROUND OF THE INVENTION

1. Field of the Invention

The present invention relates to system and method for determining applicants working process with an administrative agency based on data collection and analysis of past administrative agents performance, and more specifically there is a system and method of predicting future Patent Office actions based on the past performance of the assigned examiner and art unit for a subject patent application.

2. Description of the Related Art

In the related art, it has been known to look at statistics to reveal potential performance of stock markets, money rates, bond rates, prices of product, production schedules, manufacturing trends, political voting predictions and a whole plethora of systems and methods not listed herein.

Examples of references related to the present invention, but not teaching alone or in combination the present invention are described below, and the supported teachings of each reference are incorporated by reference herein:
U.S. Pat. No. 6,529,901 Mar. 4, 2003 Chaudhuri et al.
U.S. Pat. No. 6,613,101 Sep. 2, 2003 Mander et al.
U.S. Pat. No. 6,690,788 Feb. 10, 2004 Bauer et al.
U.S. Pat. No. 6,804,629 Oct. 12, 2004 Hashiguchi et al.
U.S. Pat. No. 7,103,562 Sep. 5, 2006 Kosiba et al.
U.S. Pat. No. 7,203,655 Apr. 10, 2007 Herbert et al.
U.S. Pat. No. 7,610,263 Oct. 27, 2009 Dettinger et al.
U.S. Pat. No. 7,447,687 Nov. 4, 2008 Andersch et al.
U.S. Pat. No. 6,173,284 Jan. 9, 2001 Brown
U.S. Pat. No. 6,591,402 Jul. 8, 2003 Chandra et al.
U.S. Pat. No. 6,631,439 Oct. 7, 2003 Saulsbury et al.
U.S. Pat. No. 6,757,580 Jun. 29, 2004 Shimada et al.
U.S. Pat. No. 6,945,458 Sep. 20, 2005 Shah et al.
U.S. Pat. No. 7,156,306 Jan. 2, 2007 Kenney
U.S. Pat. No. 7,221,377 May 22, 2007 Okita et al.
U.S. Pat. No. 7,197,508 Mar. 27, 2007 Brown, III
U.S. Pat. No. 6,324,533 Nov. 27, 2001 Agrawal et al.

What is still needed, despite all the known prior art, is a method and system for predicting the allowance outcome of patent applications that are to be issued by the US Patent and Trademark Office. The value of patents to an organization or inventor is clearly understood, and the news is full of examples how a single patent can change the course of a whole industry or stock price of a single company. Thus, it is a valuable asset or system that can assist in the more accurate prediction of the probability of patent allowance and eventual issuance.

Also, another benefit of this system and method is that management of large patent portfolio companies need to have some prediction of future costs for maintaining and developing their patent application portfolios. Some of these costs, for example, can vary by millions of dollars from year-to-year based solely on the unpredictability of the Patent Office action response and time of the response. Thus, there is a need for corporations to have more predictability of upcoming responses from the Patent Office to allow managers to more accurately allocate sufficient budgetary requirements.

Another concerning matter is the lack of knowledge about certain technologies and the probability of actually being granted a patent. Recently, for example, a relatively new patent development is the filing of business method patents focusing on the financial industry. Any one of these new patents could have a significant impact on the stock price of those financial businesses. Thus, there are many investors that would find it quite valuable to have an idea of when a particular patent application may be allowed to enable intelligent investment strategies to be implemented.

Still a further question often posed by the patent realm is “what effect does the individual examiner have on the actual allowance rate of a particular invention.” It would be valuable, for example, to know that a particular Examiner has a higher allowance rate than the other Examiners in the same art unit. Similarly, it would be equally valuable to learn that the particular Examiner on an application has the lowest allowance rate in the assigned art unit.

Another valuable piece of information would be to learn not only the particular overall allowance rate for a particular Examiner, but to learn at what step in the process is the Examiner most likely to issue the patent. For example, is there a higher allowance rate for this particular Examiner at the second rejection step, or after the final rejection, or on the first continuation? Additionally, does this particular Examiner have a high allowance rate upon appealing decisions? Knowing not only the overall allowance rate, but when the allowance is more likely to be granted can give the practitioner a probable time line for allowance of a particular patent.

Once allowance probabilities are learned for individual patents, it stands to reason that the calculations can now be made for a whole patent portfolio of pending patents. Thus, it would now be possible to learn how the competition is strategically building their portfolio by having the ongoing statistics of the Patent Office.

Yet, another question often asked by corporate counsel is that they would like to know how good their particular patent attorney is, or how good their law firms are that are servicing the building of their patent portfolio. Thus, by knowing the allowance rate of individual attorneys and their law firms, a corporate counsel will be able to pick the most suited law firm and attorney, or at least be able to better measure the performance of the work that is being performed.

Even more importantly, a vital question to answer is to learn where the stock of a particular company may be going in the future. Thus, it would be valuable to learn that a new technology is going to be issued a patent on a particular time frame, or is it going to languish in the Patent Office with a low probability allowance art unit and even lower allowance granting Examiner.

Therefore, there is a need for a device that solves one or more of the problems described herein and/or one or more problems that may come to the attention of one skilled in the art upon becoming familiar with the current specification and appended drawings.

### SUMMARY OF THE INVENTION

The present invention has been developed in response to the present state of the art, and in particular, in response to the problems and needs in the art that have not yet been fully solved by currently available template systems. Accordingly, the present invention has been developed to provide a method and/or system to provide additional statistical information involving the USPTO's pending applications to enable users of the system to make heretofore unavailable decisions involving the stock market, yearly budgets, outside counsel hiring decisions, competitor analysis, and other advantages yet to be enumerated.

While the device and methods described in the present invention have usefulness in the area of pending patent application analysis, those skilled in the art can appreciate that the device and methods can be used in a variety of different systems and in a variety of different methods.

A system for analyzing past performance of administrative agents and providing recommendations to applicants on making decisions for future responses to the administrative agents that will increase probability of allowance of the applications, comprising:
a. a computer system for automatically analyzing and providing recommendations to the applicants;
b. a receiving data module, in communication with the computer system, designed to receive data related the past performance of the administrative agents actions;
c. analyzing data module, in communication with the computer system and the receiving data module, and designed to analyze all data related to the past performance of an administrative agents actions; and
d. a display module, in communication with the analyzing data module, and designed to display to a user a report of the past performance of the administrative agent, related administrative agents performance, and complete administrative agency performance to enable a user to select a best course of action for the application to gain allowance of the application.

A computer implemented process for predicting a next course of action to increase the probability of allowance of an application that is before an administrative agent in an administrative agency, comprising: a computer system for automatically analyzing and providing recommendations to the applicants; a receiving data module, in communication with the computer system, designed to receive data related the past performance of the administrative agents actions; analyzing data module, in communication with the computer system and the receiving data module, and designed to analyze all data related to the past performance of an administrative agents actions; and a display module, in communication with the analyzing data module, and designed to display to a user a report of the past performance of the administrative agent, related administrative agents performance, and complete administrative agency performance to enable a user to select a best course of action for the application to gain allowance of the application.

A method of predicting a next course of action to increase the probability of allowance of an application that is before an administrative agent in an administrative agency, comprising: create a list of cases to monitor; monitor all transaction by the administrative agency; determine when there is a final or non-final rejection on a case that is being monitored; automatically generate a rejection alert report for each case in the list for which there was a final or non-final rejection; and deliver each rejection alert report to the appropriate applicant or practitioner.

These and other objects of the present invention will become readily apparent upon further review of the following specification and drawings.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is an allowance probability screen shot illustrating one embodiment of the illustrated invention.

FIG. 2 is a screen shot of one embodiment for a particular pending application prosecution flowchart.

FIG. 3 is a screen shot of one embodiment for a particular pending application prosecuting steps and related allowance rates and related pendency time.

FIG. 4 is a screen shot of one embodiment for a particular art unit and its Examiners with their related overall allowance rates.

FIG. 5 is a screen shot of one embodiment for particular law firms with their related overall allowance rates for a particular art unit.

FIG. 6 is a screen shot of one embodiment for particular corporations with their related overall allowance rates for a particular art unit.

FIG. 7 is a screen shot of one embodiment for art units and their related overall allowance rates.

FIG. 8 is a screen shot of one embodiment for a particular Examiner and the related overall allowance rate over time.

FIG. 9 is a flow chart of one embodiment for a process of collections and eventual delivery of reports on pending applications.

FIG. 10 is a screen shot of one embodiment for a particular report for a particular application.

FIG. 11 is a screen shot of one embodiment for the particular application of FIG. 10 illustrating steps of the patent process and the calculated statistics and pendency.

FIG. 12 is a screen shot of one embodiment for a particular report illustrating an Examiner's allowance rate compared to the overall art unit's related overall allowance rates.

FIG. 13 is a screen shot of one embodiment for a particular report illustrating the selected Examiner's overall allowance rate compared to all the individual overall allowance rate of other Examiners in the same art unit.

FIG. 14 is a screen shot of one embodiment for a particular report illustrating art units sorted by overall allowance rates.

FIG. 15 is a screen shot of one embodiment for an allowance report for art units with their related overall allowance rates by prosecution steps as compared to the overall Patent Office allowance rates by prosecution steps.

FIG. 16 is a screen shot of one embodiment for a particular report illustrating art units in which a corporation has pending applications and the related allowance rate per art unit.

FIG. 17 is a screen shot of one embodiment for a particular report illustrating all the corporations having pending applications in a particular art unit with their related overall allowance rates.

FIG. 18 is a screen shot of one embodiment for a particular report illustrating a selected corporation and a list of law firms used by that corporation in that art unit with their related overall allowance rates.

FIG. 19 is a screen shot of one embodiment for a particular report illustrating a second selected corporation and a list of law firms used by that corporation in that art unit with their related overall allowance rates.

FIG. 20 is a screen shot of one embodiment for a particular report illustrating allowance rates by prosecution steps for a particular company in a particular art unit compared to the overall allowance rate of the USPTO.

FIG. 21 is a screen shot of one embodiment for a particular report illustrating allowance rate statistics of a corporation's law firm and a competing law firm over the steps of prosecution with their related overall allowance rates.

FIG. 22 is a flow chart illustrating one embodiment for a particular process of creating cache tables from data analysis module using the patent information database.

FIG. 23 is a flow chart illustrating one embodiment for generating rejection reports.

It is noted that similar reference characters or wording denote corresponding features consistently throughout the attached drawings.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

The basis of the present invention is built around the idea of collecting previously unknown and/or unpublicized information regarding allowance rates from the USPTO and providing analysis of that data, which is thereby provided to users of such information to make valuable decisions. Such decisions may be selected from the group consisting of: calculating pending patent application budgets, predicting stock market price changes, analyzing competitor's pending patent application information, analyzing lawyer performance, analyzing law firm performance, predicting allowance dates of pending patent applications, selecting a path for patent prosecution, and others yet to be determined based on the disclose of the illustrated embodiments of this pending application.

### DEFINITIONS

Case: a patent application and its prosecution.

Practitioner: Attorney or agent responsible for a case

Prosecution Step: An action taken by an applicant including:
1. an initial patent application
2. response to non-final rejection
3. response to a final rejection
4. request for continued examination (RCE)
5. notice of appeal to the BPAI

Allowance: A notice of allowance mailed by the US PTO.

Abandonment: A notice of abandonment mailed by the US PTO.

Rejection: A final or non-final rejection mailed by the US PTO.

Pending case: An application in which there is no notice of allowance or notice of abandonment.

Pending Step: A prosecution step in which there is no subsequent action of one of the following types:
1. Notice of abandonment
2. Notice of allowance
3. Non-final rejection
4. Final rejection
5. Another prosecution step
NOTE: exceptions can be made to this definition for simplifying calculations such as ignoring subsequent RCE's when calculating RCE or notice of appeal pendency.

Disposed Step: A prosecution step which is no longer pending.

Step Pendency: The number of days between the day a Prosecution Step was received by the PTO until it was no longer pending.

Overall Pendency: The number of days between the day an application was docketed to any examiner and the day the case was no longer pending.

Step Distribution: The percentage of all allowed applications that were allowed following each type of prosecution step. For example if 100 cases were allowed, 14 following the initial application, 38 following a response to a non-final rejection, 10 following a response to a final rejection, 23 following an RCE and 15 following an appeal, the distribution would be 14%, 38%, 10%, 23% and 15% for the Application, Response to Non-Final Rejection, Response to Final Rejection, RCE and Appeal respectively.

This invention, in one embodiment, consists of a method for calculating allowance rates, allowance distribution and pendency for cases and prosecution steps based on Patent Office transaction history data and three tools that can be derived from these calculations.

The following is a description for a method for calculating allowance rates, allowance distribution and pendency for cases and prosecution steps. For Cases, the allowance rate is calculated by dividing the number of cases in which there is an allowance by the number of cases in which there is an allowance or abandonment.

| | Cases | Cases | Total | Allowance |
|---|---|---|---|---|
| Examiner | Allowed | Abandoned | Cases | Rate |
| Smith, John | 150 | 50 | 200 | 75% |
| Jones, Janet | 60 | 40 | 100 | 60% |

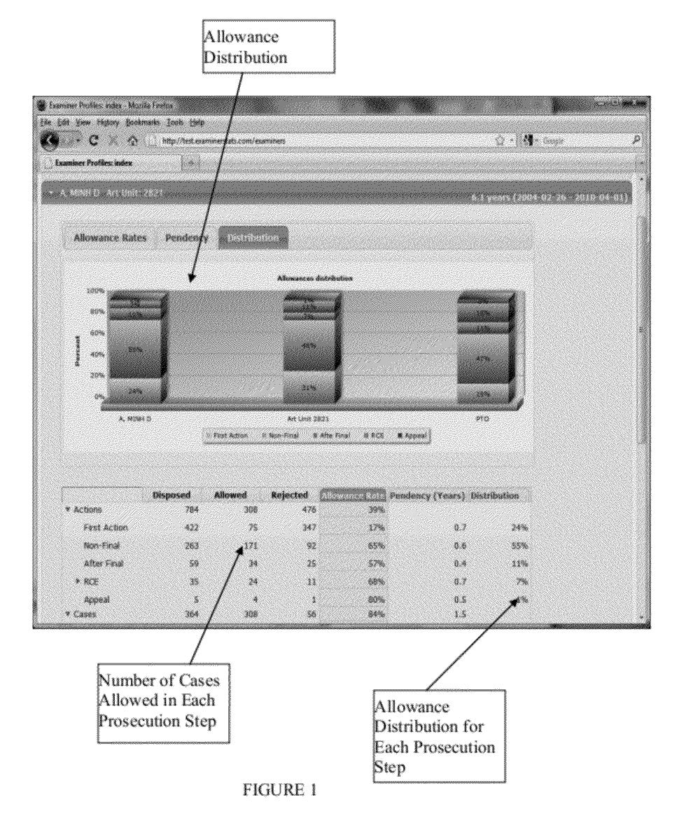

The allowance distribution, as illustrated in FIG. 1, is calculated by determining the percentage of the allowed cases that were allowed by each prosecution step. The percentage allowed by each prosecution step is calculated by dividing the number of cases allowed following the prosecution step by the number of cases allowed.

The average pendency of an examiner is measured by taking the average of the pendency of each case the examiner disposed. The pendency of a case is the number of days the case was pending. The starting date for pendency can depend on the purpose. For example, to determine the speed of an examiner, it would be useful to measure the pendency from the date the case was docketed to the examiner until the case was either allowed or abandoned (disposed). However, to determine the speed of the US PTO, it would be more useful to measure the pendency from the date the case was filed.

| Case | Docketed Date | Disposed Date | Pendency |
|---|---|---|---|
| 11/000,101 | Jan. 12, 2003 | Apr. 12, 2005 | 2.25 years |
| 12/000,101 | Jun. 1, 2005 | Jan. 1, 2009 | 3.5 years |

The Average Pendency based on this chart is (2.25 + 3.5)/2 = 2.875 years.

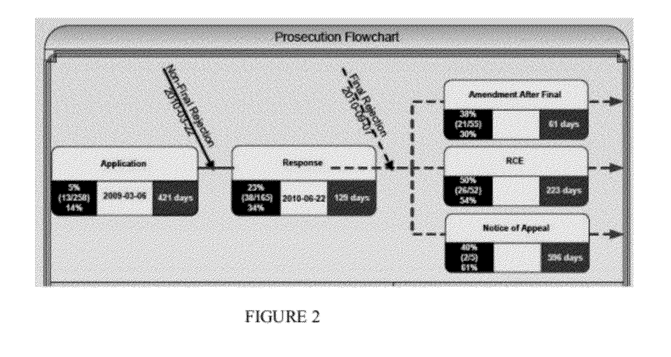

Calculations are also calculated at each step of prosecution, as illustrated in FIG. 2. These steps include the initial application, a response/amendment to a non-final rejection, a response/amendment to a final rejection, a Request for Continued Examination (RCE) and a notice of appeal to the Board of Patent Appeals and Interferences. Thus, it is possible to predict the best next steps to get the highest probable allowance.

The allowance rate for a prosecution step is calculated by dividing the number of cases that were allowed after that prosecution step but prior to any subsequent prosecution step (with the exception of the NOTE above), divided by a the number of cases in which that prosecution step is disposed.

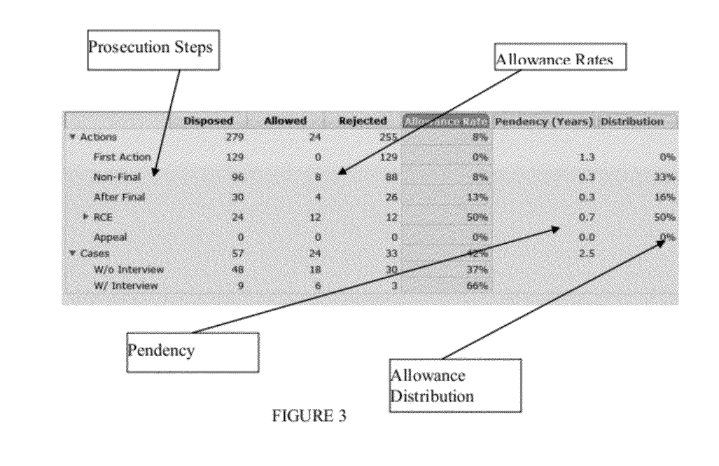

The pendency, as illustrated in FIG. 3, for a prosecution step is calculated by subtracting the date the prosecution step was not longer pending from the date the prosecution step was taken by the applicant/practitioner.

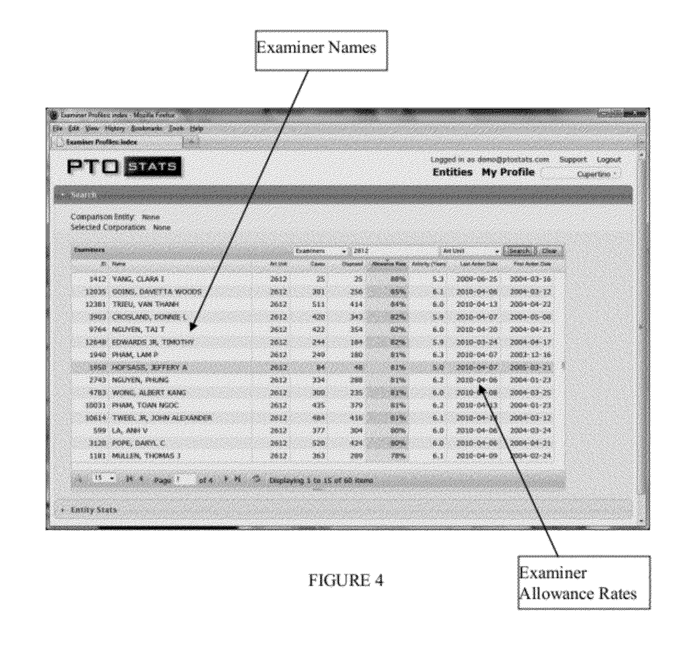

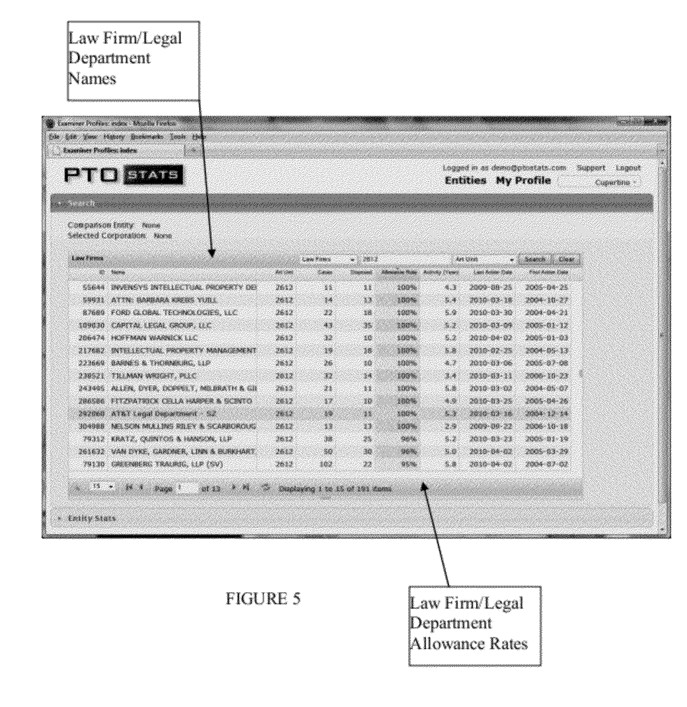

In one embodiment, Examiner calculations are done by aggregating all cases by the examiner, as illustrated in FIG. 4. Similarly, Law Firm/Legal Department calculations are done by aggregating all cases by the first line in the correspondence address filed with the patent office, as illustrated in FIG. 5. Practitioner calculations for a case are done by aggregating all cases by the name of the practitioner who signed the last prosecution step

| | Cases | Cases | Cases | Allowance |
|---|---|---|---|---|
| Practitioner | Disposed | Allowed | Abandoned | Rate |
| Thomas, Chris | 200 | 150 | 50 | 75% |
| Peters, Jim | 160 | 80 | 80 | 50% |

Practitioner calculations for a prosecution step are done by aggregating all cases by the name of the practitioner who signed that prosecution step.

| | Cases | Cases | Allowance |
|---|---|---|---|
| Prosecution Step | Allowed | Rejected | Rate |
| Initial Application | 6 | 94 | 6% |
| Response to Non-Final | 24 | 56 | 30% |
| Response to Final | 6 | 54 | 10% |
| RCE | 15 | 15 | 50% |
| Notice of Appeal | 2 | 8 | 20% |

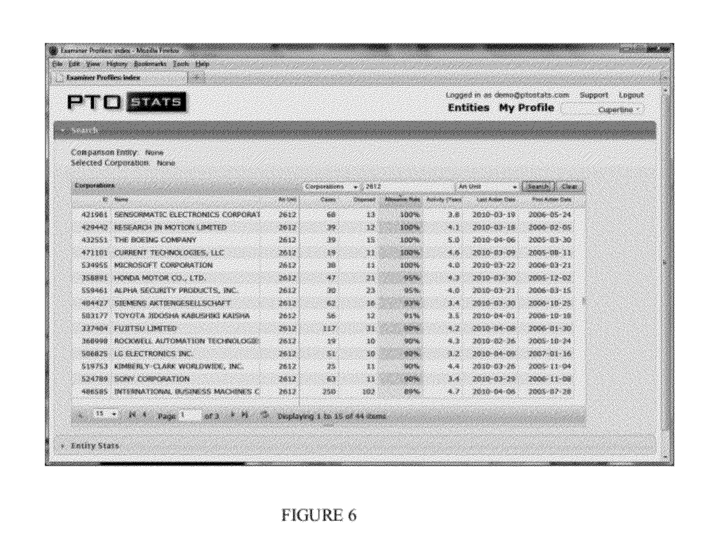

The corporation calculations, as illustrated in FIG. 6, are done by aggregating all cases by the entity to which the case was assigned.

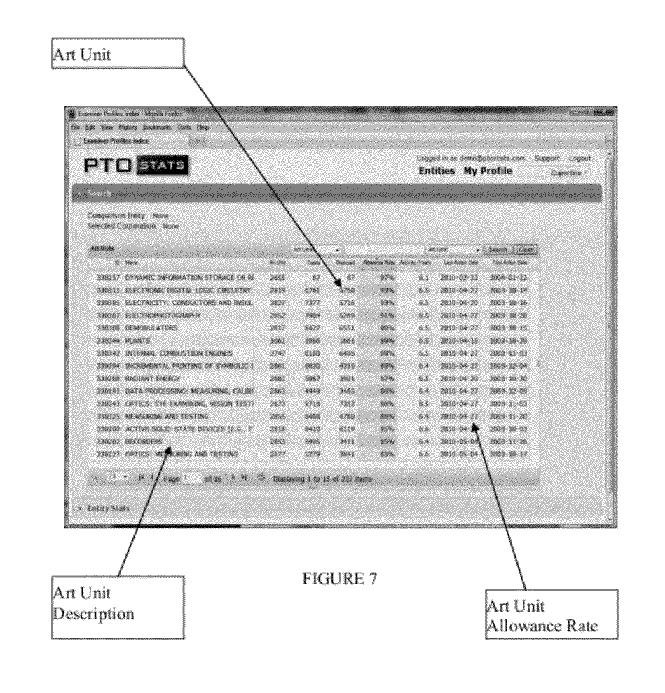

Art unit calculations, as illustrated in FIG. 7, are done by aggregating all cases by the art unit to which they were assigned. NOTE: Each entity can be sub-aggregated by any other entity. For example, calculations can be done separately for each art unit in which an examiner worked. Or, calculations can be done for each corporation each law firm worked with.

Since the allowance rates and pendency of the art units vary, in order to be able to compare the performance of entities objectively across art units, entities in different art units should be compared by comparing the difference between the entities allowance rate and pendency and those of the art unit in which the cases were filed. So entities can be compared and ranked based on the percent deviation with the art unit which is calculated by subtracting the allowance rate or pendency of the entity from that of the art units and dividing by the allowance rate or pendency of the art unit, then multiplying by 100 to get the percentage deviation.

| | | Examiner | | |
|---|---|---|---|---|
| | | Allowance | Art Unit | Examiner Percent |
| | Art | Rate in | Allowance | Deviation in Art |
| Examiner | Unit | Art Unit | Rate | Unit |
| Bronson, | 2412 | 65% | 60% | (65 − 60)/60 = 8.3% |
| Betty | | | | |
| Bronson, | 3600 | 45% | 50% | (45 − 50)/50 = −10% |
| Betty | | | | |
| Davids, | 2100 | 55% | 45% | (55 − 45)/45 = 22.2% |
| William | | | | |

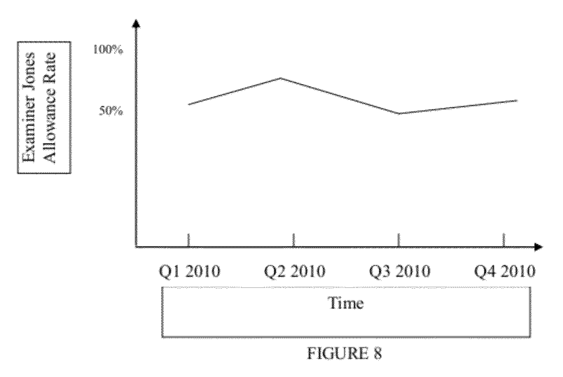

Since, as illustrated in FIG. 8, the allowance rate at the PTO changes over time, depending on the administration and case law, all the allowance rates are provided over time, such as in quarterly or semi-annual intervals.

Now that the calculations are presented, it is noted that a skilled artisan will realize that there are tools derived from the calculations. For example, in one embodiment there are applicant and/or practitioner Tools, in which there are twelve discussed herein. The first is a Rejection Alert Report. This is a report that is automatically generated in order to prepare an applicant/practitioner for responding to a US PTO office action by automatically creating a profile of the US PTO examiner who wrote the office action.

The steps in creating the rejection alert report include first creating a list of cases to be monitored. The cases can be identified by any unique bibliographic data such as the application number. Second, there is monitoring of all transactions at the PTO. Third, there is detecting when there is a final or non-final rejection to one of the monitored cases.

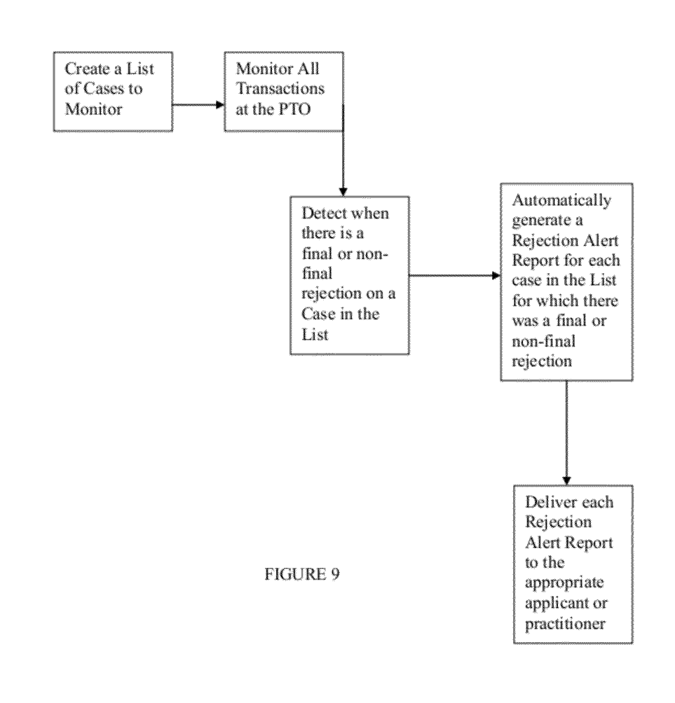

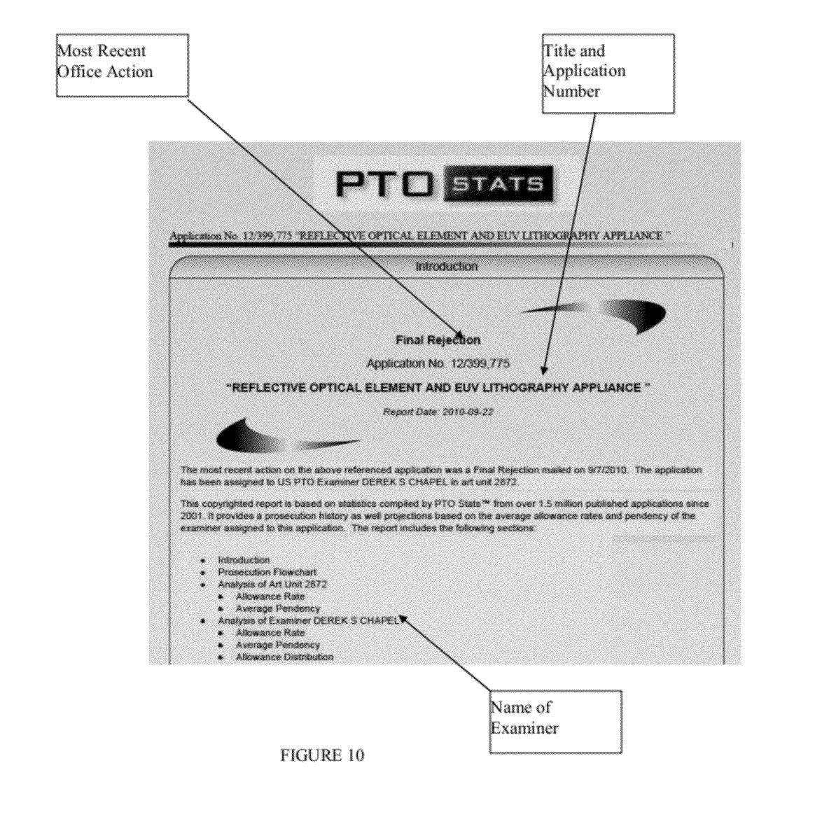

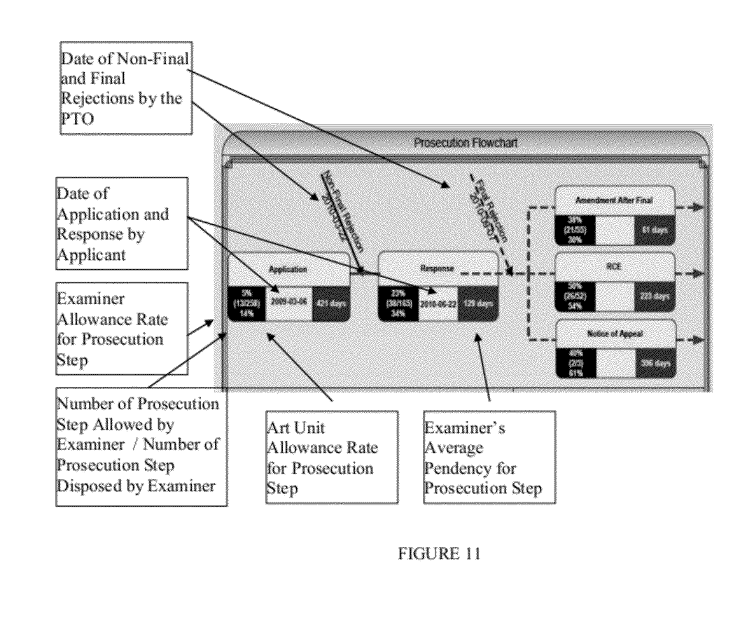

In a Fourth tool, there is automatically generating a Rejection Alert Report for the case(s) for which a final or non-final rejection was made. Fifth, the report is delivered (electronically or otherwise), as illustrated in FIG. 9, where each Rejection Alert Report to the applicant or practitioner responsible for the case. Thereby, the contents of the Rejection Alert Report includes the title, application number and other bibliographic information of the case, as related to and illustrated in FIG. 10. Next, a timeline, as illustrated in FIG. 11, of the prosecution history a possible future prosecution steps along with the allowance rates for each prosecution step for a particular administrative agent (examiner). Also, provided is the date and type of the most recent final or non-final rejection. Additionally, there is provided a comparison of the examiner's case allowance rate, allowance distribution and pendency to that of the art unit in which the case was assigned and to that of all cases in the US PTO (administrative agency employing administrative agents).

The fifth report or tool provided is a comparison of the examiner's prosecution step allowance rate and pendency to that of the art unit in which the case was assigned and to that of all cases in the US PTO.

Sixth tool includes, for each comparison, identifying the Prosecution Step with the largest variance between the examiner and the art unit and the art unit and the PTO for allowance rate and pendency.

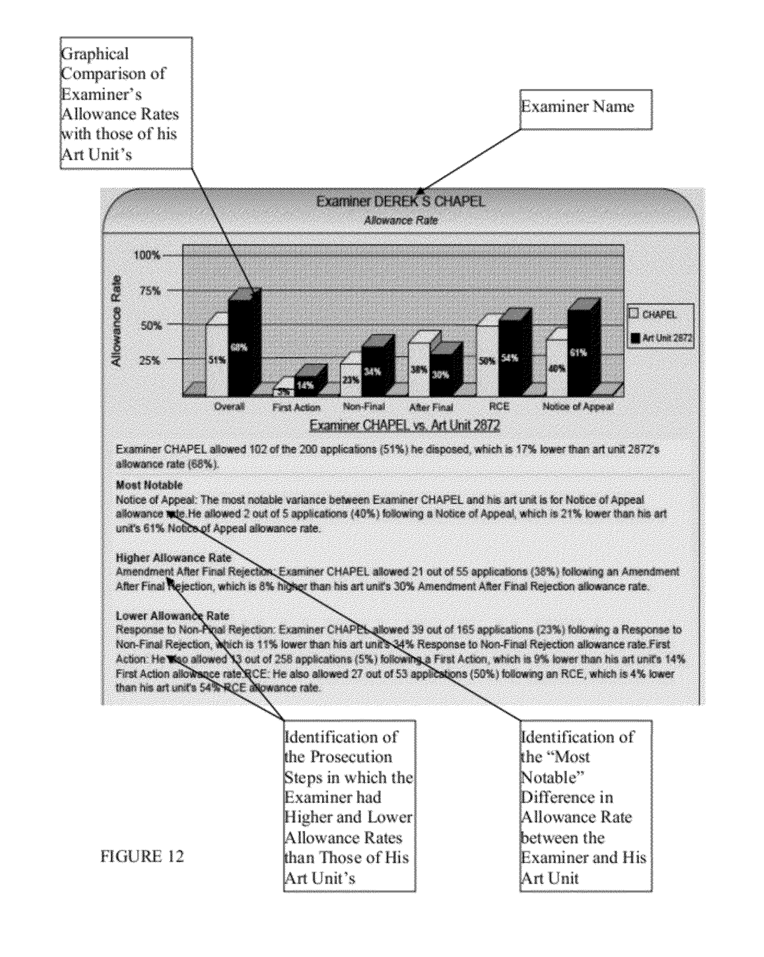

Seventh tool, for each comparison, as illustrated in FIG. 12, is the possible identification of all Prosecution Steps in which the examiner's allowance rate and pendency was higher than the art unit's and in which the art unit's was higher then the PTO's.

An eighth tool, for each comparison, is to identify all Prosecution Steps in which the examiner's allowance rate and pendency was lower than the art unit's and in which the art unit's was higher then the PTO's.

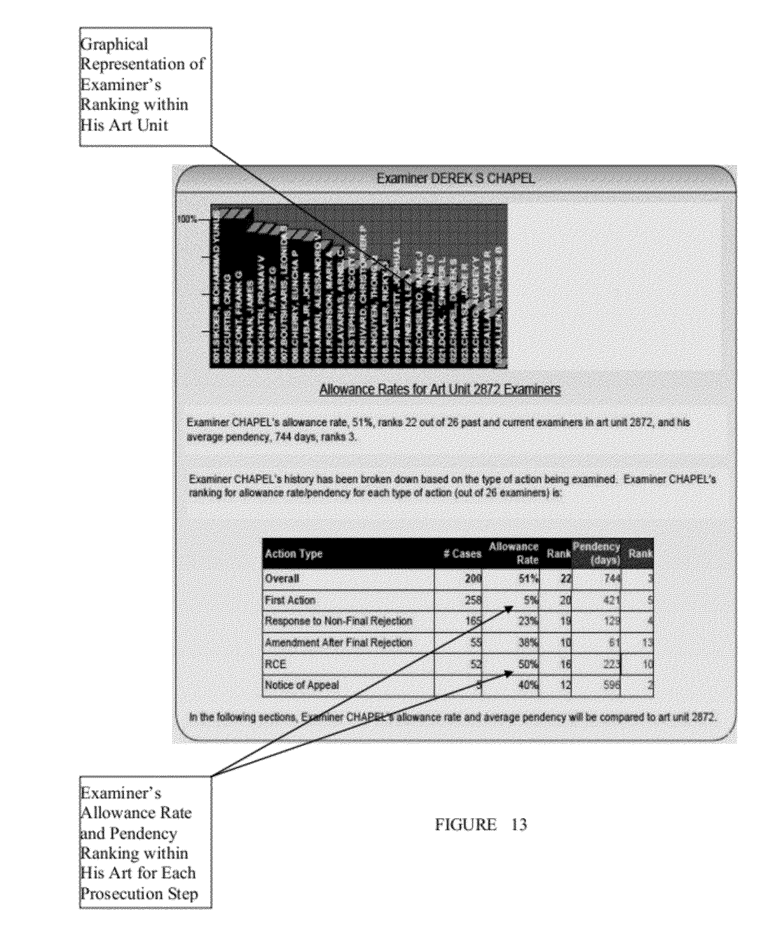

The ninth tool includes the Rank of each examiner (administrative agent) within his/her art unit (against other administrative agents doing the same or similar work) based on overall allowance rate and pendency, is illustrated in FIG. 13.

The tenth tool includes the rank of each examiner within the PTO (administrative agency) based on the variance between the examiner's allowance rate and pendency and that of his/her art unit's.

| | | Examiner | Art Unit | Allowance | | | |
|---|---|---|---|---|---|---|---|
| | Art | Allowance | Allowance | Rate | Examiner | Art Unit | Pendency |
| Examiner | Unit | Rate | Rate | Variance | Pendency | Pendency | Variance |
| E1 | 2121 | 55% | 50% | 10% | 300 | 330 | −10% |
| | | | | | days | days | |
| E2 | 2300 | 50% | 60% | −16.7% | 400 | 350 | 14% |
| | | | | | days | days | |

An eleventh tool is to rank each examiner within his/her art unit based on each Prosecution Step's allowance rate and pendency.

| | | | | Response | | | | | | | |
|---|---|---|---|---|---|---|---|---|---|---|---|
| | | | | to Non- | | Response | | | | Notice | |
| | Art | 1^{st} | | Final | | to Final | | | | of | |
| Examiner | Unit | Action | Rank | Rejection | Rank | Rejection | Rank | RCE | Rank | Appeal | Rank |
| E3 | 2450 | 10% | 6^{th} | 45% | 18^{th} | 12% | 35^{th} | 70% | 3^{rd} | 60% | 12^{th} |
| E4 | 2450 | 15% | 4^{th} | 40% | 22^{nd} | 15% | 28^{th} | 65% | 10^{th} | 66% | 8^{th} |

The twelfth tool or report may be to rank each examiner within the PTO based on the variance between each Prosecution Step's allowance rate and pendency and that of his/her art unit's.

| | | | | Response to | | Response to | | | | | |
|---|---|---|---|---|---|---|---|---|---|---|---|
| | | | | Non-Final | | Final | | | | Notice of | |
| | Art | 1^{st} Action | | Rejection | | Rejection | | RCE | | Appeal | |
| Examiner | Unit | Variance | Rank | Variance | Rank | Variance | Rank | Variance | Rank | Variance | Rank |
| E5 | 3200 | 5.35% | 325^{th} | 8.22% | 101^{st} | 22.37% | 88^{th} | 2.98% | 200^{th} | 18% | 190^{th} |
| E6 | 3300 | 6.45% | 250^{th} | 5.26% | 230^{th} | 50.32% | 30^{th} | −10% | 400^{th} | −78% | 475^{th} |

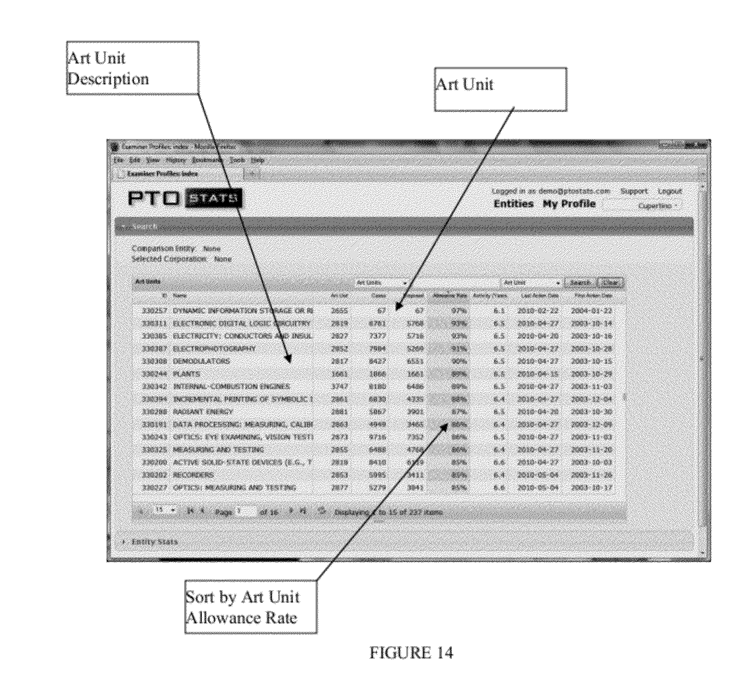

Other uses for the statistics may include art unit shopping. These statistics may help an applicant or practitioner identify the art units that have the highest allowance rate or shortest pendency that examine subject matter inclusive of the invention the practitioner is preparing. Specifically, a skilled practitioner will understand that patent applications are typically assigned using certain phraseologies in the title, abstract, or preamble of the appended independent claims. Thus, the steps included in this tool three parts: 1) providing the practitioner/applicant the ability to search for relevant art units based on a description or keywords of his/her application, 2) providing the practitioner/applicant the ability to traverse the PTO classes to identify the classes the application falls in, then displaying all the art units that examine cases in those classes, 3) as illustrated in FIG. 14, there is a way of providing the capability to sort the search results by allowance rate and pendency.

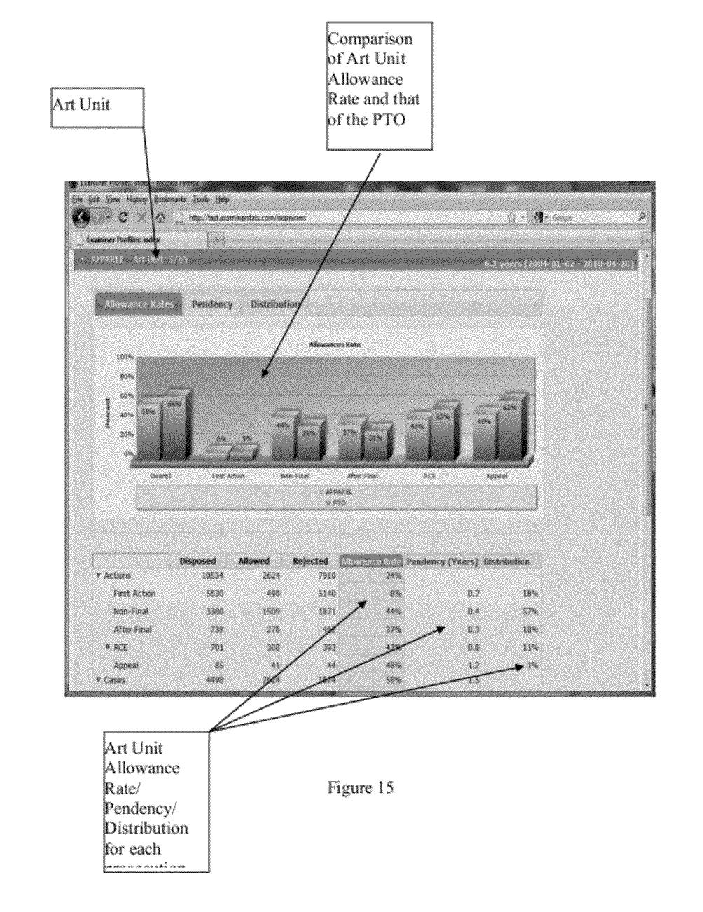

Referring to FIG. 15, there is illustrated a display of the allowance rate, allowance distribution and pendency of cases examined by each art unit in the search result as well as the allowance rate and pendency of each prosecution step.

There is also the ability to use the statistical information to perform a comparative analysis for several objectives. First, it is valuable to provide law firm comparisons. In one embodiment, the invention provides for the capability of comparing any law firm's allowance rate, allowance distribution and pendency within any art unit with that of any other law firm within the same art unit and with the overall PTO allowance averages. Additionally, it is valuable to provide the ability of comparing any law firm's allowance rate and pendency for each prosecution step within any art unit with that of any other law firm within the same art unit and with the overall PTO average.

Another use for the statistical information is to perform attorney statistics. For example, it is now possible to identify all practitioners who have filed in that art unit and their allowance rates, allowance distribution and pendency overall and for each prosecution step. Next, it is possible to compare the statistics with those of other practitioners, and law firms with those of others.

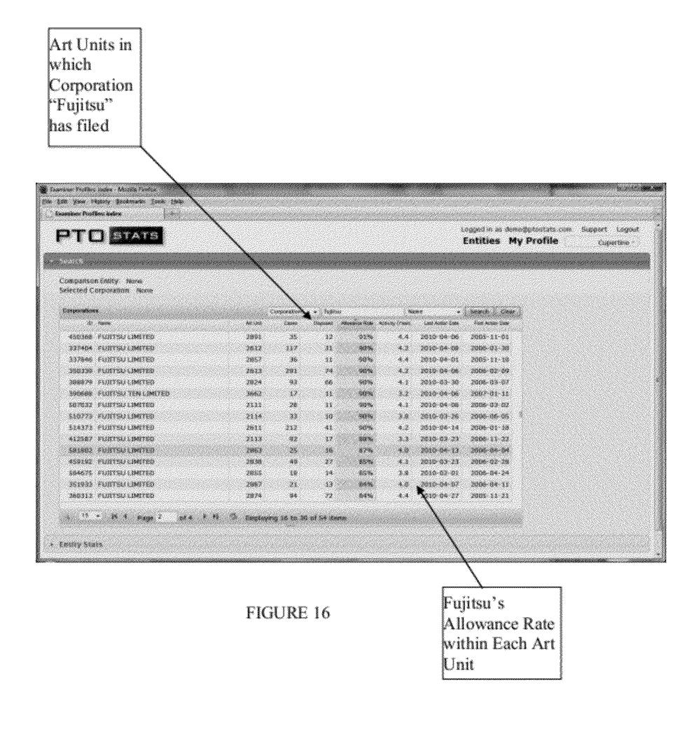

Referring now to FIG. 16, there is illustrated a screen shot for one embodiment of the invention to provide for corporate competitive analysis statistics. Specifically, the invention can identify all of the art units in which the corporation has filed applications and compare the allowance rate, allowance distribution, pendency and a deviation from the art unit averages for the cases the corporation filed in each art unit.

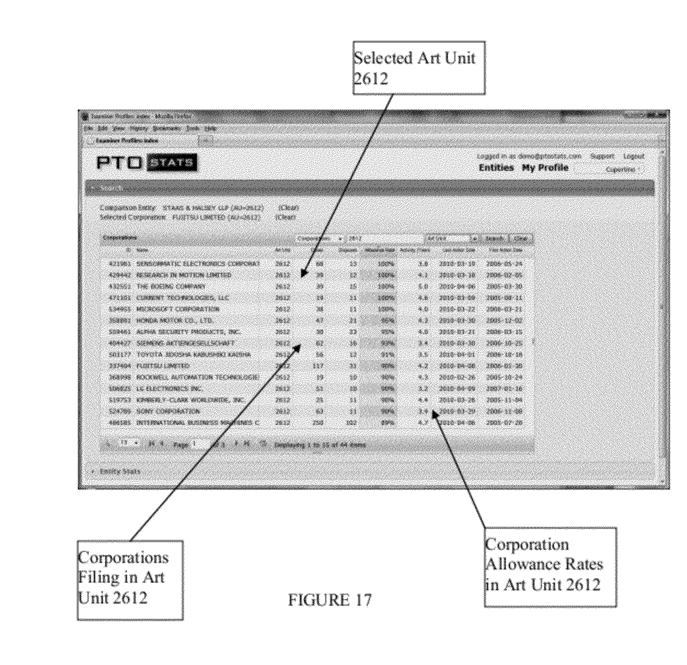

Referring to FIG. 17, there is illustrated a screen shot for a system for each art unit in which a corporation has filed applications. This allows a user to compare the corporations allowance rate, allowance distribution and pendency with those of other corporations that filed in the same art unit.

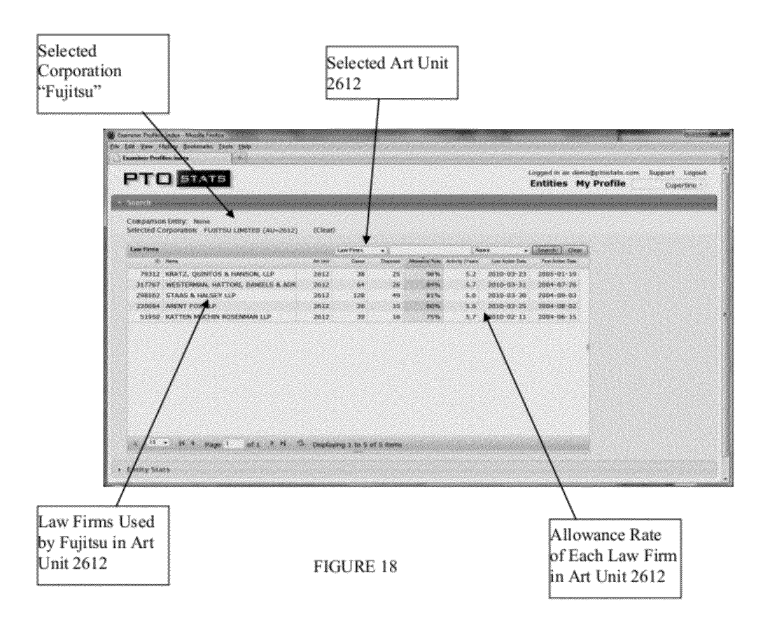

As illustrated in FIG. 18, there is a screen shot illustrating one embodiment for a system for each art unit in which a corporation has filed cases, identify all the law firms the corporation used to file cases in that art and the related allowance rate, allowance distribution and pendency of all the cases filed by each law firm on behalf of the corporation in that art unit. In other words the calculations would be for all cases in which the assignee is the corporation and the first line of the correspondence address is the law firm.

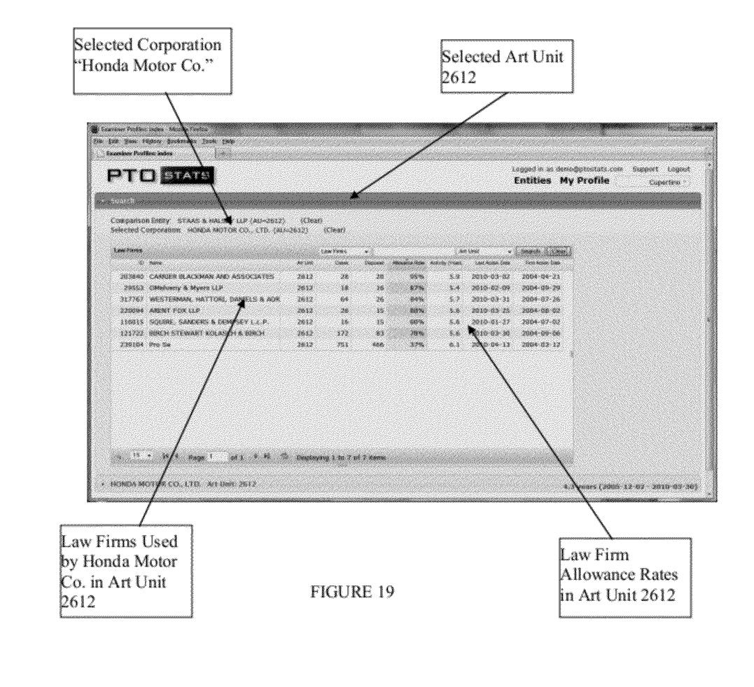

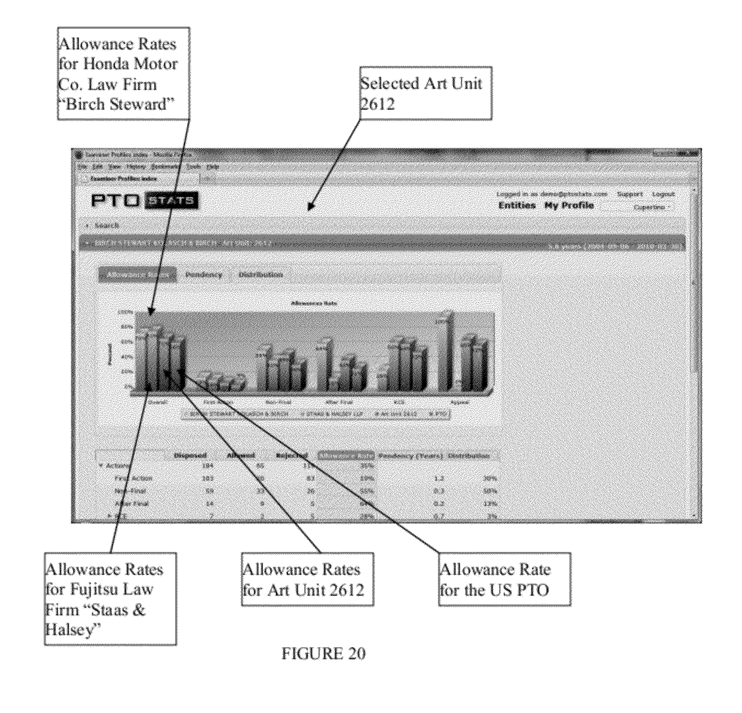

As illustrated in FIGS. 19 and 20, there is a screen shot for one embodiment teaching the method for each art unit in which a corporation has filed cases, and identify the law firms used by other corporations that filed in the same art unit. Thus, this allows for a comparison between the allowance rates, allowance distributions and pendency of those law firms with that of the law firms used by the corporation.

Based on the heretofore previously unavailable data, it is now possible to use the data as a business development tool. For example, in one embodiment, Client Target List for a law firm can be created by the following steps: a) sorting all the art units in which the law firm files applications by volume and by allowance rate, b) identifying the art units in which the law firm is strongest based on the number of applications filed and the allowance rate and pendency within those art units, c) Create a list of all the corporations that file a large volume of cases in those art unit, have a lower allowance rate than the law firm in that art unit, and/or have a longer average pendency in that art unit than the law firm.

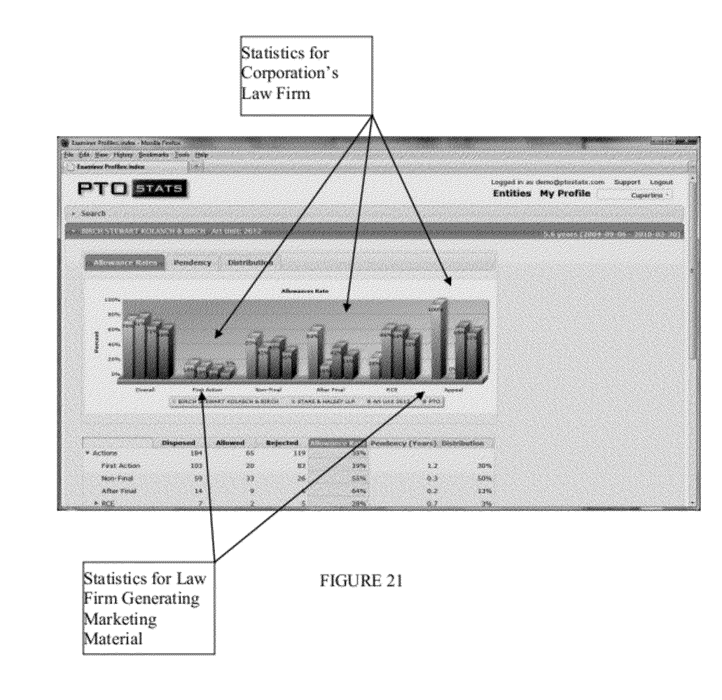

It is also possible for law firms to create targeted marketing documents, wherein marketing documents targeting a specific corporation, as illustrated in FIG. 21, are generated including the following information: a) The law firms the corporation has used to file applications, and b) A comparison of the volume, allowance rates, allowance deviation percent, and pendency of the corporation and the law firms used by the corporation with those of the law firm creating the marketing documents. For example: Step 1: Examiner Office Action Data—this is where the data exists that needs to be collected. Step 2: Data receiving module—this is the computer/step where all the data is collected into the computer system. Step 3: Data analysis module—this is where all the data is organized and analyzed into the statistical results on each examiner, art unit, step of the complete patent process. Step 4: Enquiry Module—this is where a user enquires on statistics on an examiner, art unit, class, attorney, company etc. Step 5: Comparison Module—this is where a user can enquire on comparison of data, i.e. Examiners in art unit, examiners for company, examiners for law firms, law firms for companies, etc. Step 6: Display module—this module will display the different statistics from the enquiry about attorneys, companies, examiners, and comparison statistics.

Another feature of the illustrated invention is that of entity art unit analysis. Entities are groupings by which analysis can be consolidated and art units are fields of invention such as technology centers at the US PTO. Entities can be law firms, lawyers, assignees, examiners or any other groupings based on a field or set of fields in the Patent Information Database. Since allowance rates and pendency can vary between different art units, the allowance rate and pendency analysis is done separately for each entity in each art unit. Allowance rates and pendencies are compared across art units by calculating the variance between the entities allowance rate and pendency and those of the art unit. The variance is calculated by dividing the difference between the allowance rate/pendency of the entity in the art unit and the allowance rate/pendency of the art unit divided by the allowance rate/pendency of the art unit.

Yet another embodiment of the illustrated invention involves a data analysis module. The data analysis module analyzes dates of all transactions of each case to determine whether each prosecution step was rejected or allowed, and whether each case was abandoned or allowed. A prosecution step is rejected if there is either an abandonment following the prosecution step but prior to an allowance or if there is a subsequent prosecution step without a preceding allowance. A prosecution step is allowed if there is an allowance subsequent to the prosecution step but prior to any other prosecution step. A case is abandoned if there is an abandonment with no prior allowance. A case is allowed if there is an allowance by the Examiner.

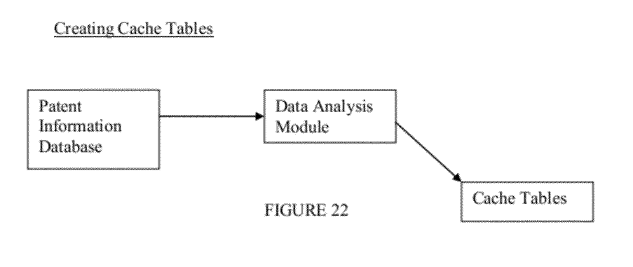

In reference to FIG. 22, there is a flow chart of a potential operation of the data analysis module, which calculates several items based on patent information database data. First, it may calculate the overall allowance rate of each art unit by dividing the number of cases in that entity/art unit that were allowed by the number of cases in that art unit that were abandoned. Next, it can calculate the allowance rate for each prosecution step for all cases in the Patent Information Database by dividing the number of times the prosecution step was allowed for all cases in the Patent Information Database by the number of times the prosecution step was rejected or allowed for all cases in the Patent Information Database. Still, the data analysis module may calculate the allowance rate of each art unit for each prosecution step by dividing the number of times the prosecution step was allowed for all cases in that art nit by the number of times the prosecution step was rejected or allowed for all cases in that art unit. The data analysis module also may calculate the overall allowance rate of each entity/art unit by dividing the number of cases relating to that entity/art unit that were allowed by the number of cases relating to that entity/art unit that were abandoned. Still, the data analysis module may calculate the allowance rate of each entity/art unit for each prosecution step by dividing the number of times the prosecution step was allowed for all cases related to that entity/art nit by the number of times the prosecution step was rejected or allowed for all cases related to that entity/art unit. Finally, in another embodiment, the database analysis module may calculates the overall allowance rate of each entity/art unit by dividing the number of cases relating to that entity/art unit that were allowed by the number of cases relating to that entity/art unit that were abandoned. All of the above listed analysis may be stored in common cache tables, as illustrated in FIG. 22. The cache tables have a separate row for each entity art unit and provide the calculations such as overall allowance rate and pendency and prosecution step allowance rate and pendency for that entity art unit. The cache tables also are intended to store the calculations for the art units and overall for all applications.

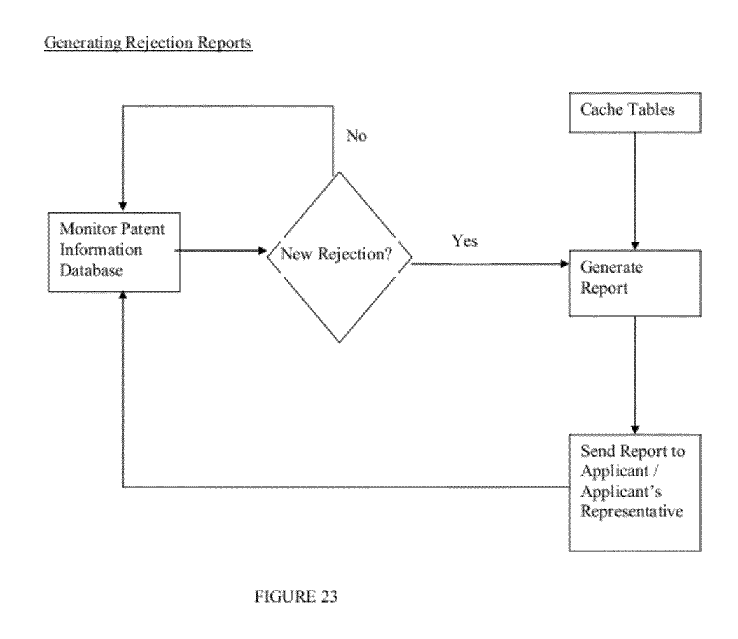

Referring now to FIG. 23, there is a flow chart illustrating one embodiment for a report module designed for generating rejection reports. Specifically, for each application number sent to the Report Module, there is generated a Rejection Alert Report. The method monitors the patent information database in the Patent Office to determine if a new rejection has been entered into that database. If a new rejection (or Office Action of any kind) has been entered into the database, there is generated a report, incorporating all or some of the above described screen shots, based on the information stored in the cache tables. Thereby, the generating Office Action (rejection) reports module sends each Rejection Alert Report to the applicant, the applicant's representative, or a user of the reports.

After the Office Action report is forwarded to the user, this information is then used to make decisions. Such decisions that are made include deciding which course of prosecution to take, like appeal, file a response to final rejection, or file for a continuing patent application with a preliminary amendment.

It is to be understood that the present invention is not limited to the embodiments described above, but encompasses any and all embodiments within the scope of the following claims.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is desired to be claimed under the U.S. Constitution Article I, Section 8, Clause 8, “To promote the progress of science and useful arts, by securing for limited times to authors and inventors the exclusive rights to their respective writings and discoveries”, is herein set forth as follows:

1. A system for analyzing past performance of administrative agents and providing recommendations to applicants on making decisions for future responses to the administrative agents that will increase probability of allowance of the applications, comprising:
a. a computer system for automatically analyzing and providing recommendations to the applicants;
b. a receiving data module, in communication with the computer system, designed to receive data related the past performance of the administrative agents actions;
c. analyzing data module, in communication with the computer system and the receiving data module, and designed to analyze all data related to the past performance of an administrative agents actions; and
d. a display module, in communication with the analyzing data module, and designed to display to a user a report of the past performance of the administrative agent, related administrative agents performance, and complete administrative agency performance to enable a user to select a best course of action for the application to gain allowance of the application.

2. A computer implemented process for predicting a next course of action to increase the probability of allowance of an application that is before an administrative agent in an administrative agency, comprising:
a. a computer system for automatically analyzing and providing recommendations to the applicants;
b. a receiving data module, in communication with the computer system, designed to receive data related the past performance of the administrative agents actions;
c. analyzing data module, in communication with the computer system and the receiving data module, and designed to analyze all data related to the past performance of an administrative agents actions; and
d. a display module, in communication with the analyzing data module, and designed to display to a user a report of the past performance of the administrative agent, related administrative agents performance, and complete administrative agency performance to enable a user to select a best course of action for the application to gain allowance of the application.

3. A method of predicting a next course of action to increase the probability of allowance of an application that is before an administrative agent in an administrative agency, comprising:
a. create a list of cases to monitor;
b. monitor all transaction by the administrative agency;
c. determine when there is a final or non-final rejection on a case that is being monitored;
d. automatically generate a rejection alert report for each case in the list for which there was a final or non-final rejection; and
e. deliver each rejection alert report to the appropriate applicant or practitioner.
